(19) United States
(12) Patent Application Publication
(10) Pub. No.: US 2018/0086925 A1
(43) Pub. Date: Mar. 29, 2018

(54) COMPOSITIONS AS PAINT ADDITIVES AND THEIR USES

(71) Applicant: Imerys Talc Europe, Toulouse (FR)

(72) Inventors: Agnès FIOLET, Toulouse (FR); Emmanuel BERTIN, Toulouse (FR); Mohieddine BALTI, Toulouse (FR)

(21) Appl. No.: 15/568,194

(22) PCT Filed: Apr. 20, 2016
(86) PCT No.: PCT/EP2016/058736

§ 371 Date: Oct. 20, 2017

(30) Foreign Application Priority Data
Apr. 20, 2015 (EP) 15290108.8

(51) Int. Cl. C09D 7/12; C09D 7/00; C09D 5/00

(52) U.S. Cl. CPC C09D 7/1216; C09D 7/1283; C08K 3/36; C09D 5/00; C09D 7/005

(57) ABSTRACT

A particulate composition comprising SiO₂ and MgO is provided, which composition is characterized by a bimodal particle size distribution. The particulate composition provides unexpected benefits in particular as a paint additive, in terms of improved optical as well as physical characteristics for the paint product.

### CLAIM FOR PRIORITY

This application is a U.S. national phase entry under 35 U.S.C. § 371 from PCT International Application No. PCT/EP2016/058736, filed Apr. 20, 2016, which claims the benefit of priority of EP Application No. 15290108.8, filed Apr. 20, 2015, to both of which this application claims priority and both of which are incorporated herein by reference.

### TECHNICAL FIELD

The present invention is directed to particulate compositions to be used as paint additives, to methods for improving the properties of a paint product using said compositions, and to uses of said compositions as an additive for paint products.

### BACKGROUND OF THE INVENTION

Paint products are usually required to have a number of differing characteristics, which can be classified under optical characteristics and physical characteristics.

Amongst the optical characteristics desirable for a paint product are features such as the whiteness of the product, its opacity and the white tint strength.

In terms of whiteness, titanium dioxide is one of the most widely used white pigments. Because the supply of TiO₂ may at times be problematic, there is a need to use extenders, which allow for the complementing or extending of the TiO₂.

The physical characteristics which may be desirable for a paint product include its resistance to scrub, its resistance to cracking, its anti-corrosion properties, and its durability.

There is currently a need for a paint additive which is efficient in improving both the optical and the physical characteristics of a paint product.

### SUMMARY OF THE INVENTION

According to a first aspect of the present invention, there is provided a particulate composition comprising SiO₂ in an amount greater or equal to 55% by weight and comprising Mg( )in an amount lower or equal to 30% by weight, which composition is characterized by a bimodal particle size distribution exhibiting, when measured by laser diffraction, a first peak from about 1 μm to about 10 μm, and a second peak from about 15 μm to about 150 μm.

In accordance with a second aspect of the present invention, there is provided a resin or an ink composition, or a paint or cosmetic product, which composition or product comprises the particulate composition according to the first aspect of the invention.

In accordance with a third aspect of the present invention, there is provided a method for improving a paint product which comprises the step of adding to the paint product a particulate composition according to the first aspect of the invention.

In accordance with a fourth aspect of the present invention, use of a particulate composition according to the first aspect of the invention as an additive for improving the properties of a paint is provided.

### DETAILED DESCRIPTION OF THE INVENTION

Definitions

As used herein, the term “paint” means any coating composition, including but not limited to oil- and water-based paints, sealants, architectural coatings, and industrial coatings (e.g., coatings other than paper coatings).

As used herein in the context of paint products, a “binder” is a polymeric substance, which is either dissolved in the paint or suspended in it by emulsifiers. A binder exists to hold the paint pigment to the surface. As employed herein, “resin” has the same meaning as “binder”.

As used herein, in the context of paint products, the terms “Pigment Volume Concentration”, or “PVC”, is used to define the amount of pigment in the paint product compared to the amount of binder. Flat paints have a very high pigment loading and have high PVCs (e.g. in the range of 55% to 80%). Primers and undercoats vary from 30% to about 50% PVC as do semi-gloss, satin and low sheen paints. Gloss coloured paints can vary from 3% to about 20% PVC depending on the colour of the paint. Generally the darker the colour of the gloss paint the lower the PVC. As a general rule, the lower the PVC of a paint is, the better its exterior durability will be. PVC is always expressed as a percentage. The lower the PVC the less pigment there is in a paint and the glossier it is likely to be.

As used herein, the term “talc” means either the magnesium silicate mineral, or the mineral chlorite (magnesium aluminium silicate), or a mixture of the two, optionally associated with other minerals, for example, dolomite and/or magnesite, or furthermore, synthetic talc.

Particulate Composition

In certain embodiments, the invention provides a particulate composition comprising SiO₂ and MgO, characterized by a bimodal particle size distribution.

In some embodiments, the particulate composition of the invention comprises SiO₂ at a level of 55% by weight or more.

In other embodiments, the particulate composition of the invention comprises SiO₂ at a level of 60% by weight or more, such as for example a level of 61% by weight or more.

In some embodiments, the particulate composition of the invention comprises SiO₂ at a level of 65% by weight or less, or at a level of 65% by weight or less and more than 0% by weight.

In other embodiments, the particulate composition of the invention comprises SiO₂ at a level of 63% by weight or less, or at a level of 63% by weight or less and more than 0% by weight.

In some embodiments, the particulate composition of the invention comprises MgO at a level of 30% by weight or less, or at a level of 30% by weight or less and more than 0% by weight.

In other embodiments, the particulate composition of the invention comprises MgO at a level of 29% by weight or less, or at a level of 29% by weight or less and more than 0% by weight.

In yet other embodiments, the particulate composition of the invention comprises MgO at a level of 28% by weight or less, or at a level of 28% by weight or less and more than 0% by weight.

In some embodiments, the particulate composition of the invention comprises MgO at a level of 10% by weight or more.

In other embodiments, the particulate composition of the invention comprises MgO at a level of 20% by weight or more.

In some embodiments, the particulate composition of the invention comprises Al₂O₃ at a level of 2% by weight or more.

In other embodiments, the particulate composition of the invention comprises Al₂O₃ at a level of 3% by weight or more.

In yet other embodiments, the particulate composition of the invention comprises Al₂O₃ at a level of 3.5% by weight or more.

In some embodiments, the particulate composition of the invention comprises Al₂O₃ at a level of 15% by weight or less, or at a level of 15% by weight or less and more than 0% by weight.

In other embodiments, the particulate composition of the invention comprises Al₂O₃ at a level of 9% by weight or less, or at a level of 9% by weight or less and more than 0% by weight.

In some embodiments, the particulate composition of the invention comprises K₂O at a level of 0.1% by weight or more.

In other embodiments, the particulate composition of the invention comprises K₂O at a level of 0.3% by weight or more.

In yet other embodiments, the particulate composition of the invention comprises K₂O at a level of 0.5% by weight or more.

In some embodiments, the particulate composition of the invention comprises K₂O at a level of 1.0% by weight or less, or at a level of 1.0% by weight or less and more than 0% by weight.

In other embodiments, the particulate composition of the invention comprises K₂O at a level of 0.8% by weight or less, or at a level of 0.8% by weight or less and more than 0% by weight.

In some embodiments of the invention, the bimodal particle size distribution of the particulate composition of the invention exhibits, when measured by laser diffraction, a first peak from about 1 μm to about 10 μm, and a second peak from about 15 μm to about 150 μm.

In other embodiments of the invention, the bimodal particle size distribution of the particulate composition of the invention exhibits, when measured by laser diffraction, a first peak from about 2 μm to about 5 μm, and a second peak from about 30 μm to about 50 μm.

In certain embodiments, the particulate composition of the invention was surprisingly found to have a combination of desirable characteristics when mixed with paint products. In particular, the particulate composition was found to enhance the paint optical characteristics while at the same time enhancing the paint physical characteristics. The particulate composition can also provide improvements in stain blocking resistance, stain resistance and burnish resistance.

Amongst the optical characteristics which were found to be improved by the particulate composition of the invention were the whiteness, dry opacity, and matting effect of the paint.

Amongst the physical characteristics which were found to be improved by the particulate composition of the invention were the barrier properties, the resistance to scrub, the resistance to cracking, the anti-corrosion properties, and the durability of the paint.

In the context of paint products, the particulate composition of the invention was additionally surprisingly found to provide utility as a titanium dioxide extender and/or a binder extender.

In certain embodiments, the particulate composition of the invention allows the replacement of up to 25% titanium dioxide in paint products without any loss of dry opacity or other key properties.

In other embodiments, the particulate composition of the invention allows the replacement of up to 5%, up to 10%, up to 15%, or up to 20% titanium dioxide in paint products without any loss of dry opacity or other key properties.

In some embodiments, the particulate composition of the invention allows the replacement up to 20% of the binder in paint products without impacting any physical or optical characteristic of the paint product.

In other embodiments, the particulate composition of the invention allows the replacement of up to 5%, up to 10%, or up to 15% of the binder in paint products without impacting any physical or optical characteristic of the paint product.

Particulate Composition Components

In certain embodiments, the particulate composition comprises a silicate, a phyllosilicate, talc, chioritic talc, chlorite, an alkaline earth metal carbonate or sulphate, such as calcium carbonate, magnesium carbonate, dolomite, gypsum, a hydrous kandite clay such as kaolin, halloysite or ball clay, an anhydrous (calcined) kandite clay such as metakaolin or fully calcined kaolin, mica, perlite or diatomaceous earth, or magnesium hydroxide, or aluminium trihydrate, quartz, or combinations thereof.

In some embodiments of the invention, the bimodal particle size distribution of the particulate composition of the invention exhibits, when measured by laser diffraction, a first peak from about 1 μm to about 10 μm, and a second peak from about 15 μm to about 150 μm.

In other embodiments of the invention, the bimodal particle size distribution of the particulate composition of the invention exhibits, when measured by laser diffraction, a first peak from about 2 μm to about 5 μm, and a second peak from about 30 μm to about 50 μm.

When specified as measured by laser diffraction, the size of particles in powders, suspensions and emulsions may be measured using the diffraction of a laser beam, based on an application of Mie theory. Such a machine, for example a Malvern Mastersizer S or Mastersizer 2000 (as supplied by Malvern Instruments), provides measurements and a plot of the cumulative percentage by volume of particles having a size, referred to in the art as the ‘equivalent spherical diameter’ (e.s.d), less than given e.s.d values. The mean particle size d₅₀ is the value determined in this way of the particle e.s.d at which there are 50% by volume of the particles which have an equivalent spherical diameter less than that d₅₀ value. For the avoidance of doubt, the measurement of particle size using laser light scattering is not an equivalent method to the sedimentation method. In particular embodiments, the laser diffraction analysis is performed according to ISO 13320-1.

Advantageously, in some embodiments of the invention, the particulate composition has a d₅₀, when measured by laser diffraction, ranging from 0.5 to 30 μm. For example, the d₅₀ of the fine fraction may be ranging from 1 to 10 μm, or from 10 to 30 μm.

In some embodiments of the invention, the particulate composition has a d₉₀, when measured by laser diffraction, ranging from 15 to 90 μm. In some embodiments of the invention, particulate composition has a d₉₅ ranging from 15 to 110 μm.

In some embodiments of the invention, the particle size distribution of the particulate composition of the invention exhibits, when measured by laser diffraction, at least two fractions of particles of different mean particle sizes d₅₀.

These fine and coarse fractions of the particulate composition of the invention have particle size distributions which are adapted to optimize the improvements brought by the particulate composition of the invention to paint products, specifically in terms of optical and physical characteristics improvements.

Advantageously, in some embodiments of the invention, the fine particle fraction has a d50, when measured by laser diffraction, ranging from 1 to 10 μm. For example, the d₅₀ of the fine fraction may be ranging from 2 to 5 μm, such as from 2.5 to 4.0 μm.

Advantageously, in some embodiments of the invention, the coarse particle fraction has a d₅₀, when measured by laser diffraction, ranging from 15 to 150 μm. For example, the d₅₀ of the coarse fraction may be ranging from 30 to 50 μm, such as from 35 to 45 μm.

A particulate composition component according to certain embodiments of the present invention may have a d₅₀ ranging from 1 to 10 μm. For example, the d₅₀ of the particulate composition component may be ranging from 1.0 to 7.5 μm, such as from 2.0 to 5.0 μm, or from 2.5 to 4.0 μm.

In certain embodiments, a particulate composition component has a d₁₀ of from about 0.5 to about 10 μm, for example, from about 0.5 to about 5 μm, or from about 0.5 to about 3 μm, or from about 1 to about 10 μm, or from about 1 to about 5 μm, or from about 1 to about 3 μm.

In certain embodiments, a particulate composition component has a d₉₀ of from about 4 to about 15 μm, for example, from about 4 to about 10 μm, or from about 4 to about 7 pm, or from about 4 to about 6 μm.

In certain other embodiments, a particulate composition component has a d₉₀ of from about 15 to about 90 μm, for example, from about 15 to about 85 μm, or from about 15 to about 80 μm.

In certain embodiments, a particulate composition component has a d₉₅ of from about 5 to about 15 μm, for example, from about 5 to about 10 μm, or from about 5 to about 8 pm, or from about 5 to about 7 μm.

In certain other embodiments, a particulate composition component has a d₉₅ of from about 15 to about 110 μm, for example, from about 15 to about 100 μm, or from about 15 to about 95 μm, or from about 15 to about 90 μm, or from about 15 to about 60 μm, or from about 15 to about 58 μm.

In certain embodiments, a particulate composition component has a do of less than about 1 μm, and/or a d₁₀ of less than about 5 μm, and/or a d₅₀ of less than about 7.5 μm, and/or a d₉₀ of less than about 10 μm, and/or a d9₅ of less than about 15 μm. In certain embodiments the particulate composition component has a dₒ of from about 0.4 to about 0.75 μm, and/or a d₁₀ of from about 0.5 to about 275 μm, and/or a d₅₀ of from about 1 to about 7.5 μm, and/or a d₉₅ of from about 5 to about 10 μm.

In certain embodiments, a particulate composition component has a Hegman fineness of 3.0 or more, for example, from about 3.0 to about 4.5, or from about 3.0 to about 4.25, or from about 3.0 to about 4.0. In certain embodiments, the particulate composition component has a Hegman fineness of about 3.0, or about 3.25, or about 3.5, or about 3.75, or about 4.0, or about 4.25, or about 4.5. In certain embodiments, the particulate composition component has a Hegman fineness which is within the range of ±1 of the Hegman fineness of the inorganic particulate material feed material from which the component is prepared, for example, within the range of ±0.5 or, for example, within the range of ±0.25 of the Hegman fineness of the inorganic particulate material feed material. The test for measuring Hagman fineness is based on ASTM D-1210-05 (2010). In a preferred method, 25 g of vegetable oil are provided. After adding a 5 g sample, the mixture is kept stirring for 15 to 30 seconds. When no dry powder is visually present anymore, the mixing speed is increased to the highest reasonable speed without splashing the sample and mixing is continued for at least 2 minutes. Using a spatula or glass rod, the dispersion is stirred manually. A small amount of dispersed sample is placed in the deep end of the path of the Hegman fineness gage (Precision Gage & Tool Co., Dayton, Ohio). By using a steel draw-down blade/scraper, the material is then drawn down the length of the path toward the shallow end of the gage with a uniform, brisk motion. The fineness reading, in Hegman units (0-8) is obtained by observing the point where the material first shows a definite speckled pattern. Typical fineness patterns described in the ASTM D 1210-05 (2010) procedure can be used for comparison.

In some embodiments, the particulate composition comprises from 40% to 90% by weight of a first particulate composition component. In other embodiments, it comprises from 50% to 80% by weight of a first particulate composition component. in yet other embodiments, it comprises from 60% to 70% by weight of a first particulate composition component.

In some embodiments, the particulate composition comprises from 1% to 30% by weight of a second particulate composition component. in other embodiments, it comprises from 5% to 25% by weight of a second particulate composition component. In yet other embodiments, it comprises from 10% to 20% by weight of a second particulate composition component.

In some embodiments, the particulate composition comprises from 1% to 15% by weight of a third particulate composition component. In other embodiments, it comprises from 5% to 10% by weight of a third particulate composition component. In yet other embodiments, it comprises from 6% to 9% by weight of a third particulate composition component.

In some embodiments, the particulate composition comprises from 1% to 30% by weight of a fourth particulate composition component. In other embodiments, it comprises from 5% to 20% by weight of a fourth particulate composition component. In yet other embodiments, it comprises from 10% to 15% by weight of a fourth particulate composition component.

The particulate composition of the invention may be used as an additive in paint and cosmetic products, and in resin and ink compositions.

Methods

Certain embodiments of the methods of the invention include a method for improving a paint product, which comprises a step of adding a particulate composition of the invention to a paint product followed by a step of mixing to produce the improved paint product.

In some embodiments, the method for improving a paint product according to the invention includes the addition of from about 1% to about 30% by weight of the particulate composition of the invention.

In other embodiments, the method for improving a paint product according to the invention includes the addition of from about 1% to about 10% by weight of the particulate composition of the invention.

In other embodiments, the method for improving a paint product according to the invention includes the addition of from about 3% to about 8% by weight of the particulate composition of the invention.

In yet other embodiments, the method for improving a paint product according to the invention includes the addition of from about 5% to about 6% by weight of the particulate composition of the invention.

Physical Characteristics Measurement Methods

Wet scrub resistance to repeated cleaning wear is measured according to ISO 11998. This protocol describes a short version of the scrub abrasion test. It uses “3M Scotch Brite 7448” pads and the washing liquid is manually applied before starting the test. The test is finished for evaluation after 200 scrub-cycles. The evaluation of the wash/scrub resistance is done by calculating the loss of mass. For example, Class 1 is defined as a loss of less than 5 microns after 200 scrub-cycles. Class 2 is defined as a loss of between 5 microns and less than 20 microns after 200 scrub-cycles. Class 3 is defined as a loss of between 20 microns and less than 70 microns after 200 scrub-cycles.

Cracking Resistance Measurements Methods.

Dry paints sometimes cracks due to tension when a paint film forms. The cracking resistance of a coating is dependent on its thickness.

For the assessment of cracking resistance of a given paint product, the paint may for example be applied to a plasterboard with the use of a metallic bar to control the paint thickness (set for example at different values between 300 and 1500 μm). The paint is subsequently allowed to dry and a determination of the thickness value at which the paint starts cracking is made. A paint product with a higher thickness value at which the paint starts cracking will display a better resistance to cracking.

Optical Characteristics Measurement Methods

The dry opacity optical parameter is defined as the contrast ratio, which is calculated as the ratio of illuminance (Y) of the test material when it is placed on a black background (Yb) to the illuminance of the same material when it is placed over a white background (Yw), measured using a colorimeter.

Gloss is usually measured using a glossmeter. The measurement results of a glossmeter are related to the amount of reflected light from a black glass standard with a defined refractive index. The ratio of reflected to incident light for the specimen, compared to the ratio for the gloss standard, is recorded as gloss units (GU). Measurement angle refers to the angle between the incident and reflected light.

In some embodiment, a measurement angle of 85° is used, which is convenient for gloss measurements in the low gloss range i.e. if the result is less than 10 gloss units.

Products and Uses

Certain embodiments of the present invention comprise products which incorporate an exemplary particulate composition according to the invention.

These products include paint products, cosmetic products, as well as ink compositions and resin compositions.

The particulate composition of the invention may function to enhance the colour tones and gloss of such products and compositions and to improve their dimensional accuracy and strength.

In certain embodiments, the particulate composition of the invention is used with paint products having a PVC level above 30%. In other embodiments, the particulate composition of the invention is used with paint products having a PVC level above 40%.

In other embodiments, the particulate composition of the invention is used with paint products having a PVC level above 50%. In other embodiments, the particulate composition of the invention is used with paint products having a PVC level above 60%.

In yet other embodiments, the particulate composition of the invention is used with paint products having a PVC level above 70%.

The invention also includes uses of the particulate composition as a filler.

In some embodiments, the invention includes use of a particulate composition of the invention for improving the optical and physical characteristics of a paint product. The optical characteristics include whiteness, dry opacity, and matting effect of the paint. The physical characteristics include barrier properties, resistance to scrub, resistance to cracking, anti-corrosion properties, and durability of the paint.

In certain embodiments, a paint product including the particulate composition of the invention has a dry opacity ranging from 85% to 100% Yb/Yw. In other embodiments, a paint product including the particulate composition of the invention has a dry opacity ranging from 85% to 95% Yb/Yw. In yet other embodiments, a paint product including the particulate composition of the invention has a dry opacity ranging from 88% to 92% Yb/Yw.

In certain embodiments, a paint product including the particulate composition of the invention has a gloss 85° ranging from 0 to 3 gloss units. In other embodiments, a paint product including the particulate composition of the invention has a gloss 85° ranging from 1 to 3 gloss units. In yet other embodiments, a paint product including the particulate composition of the invention has a gloss 85° ranging from 2 to 3 gloss units.

In other embodiments, a paint product including the particulate composition of the invention has a scrub resistance ranging from Class 3 to Class 1. In yet other embodiments, a paint product including the particulate composition of the invention has a scrub resistance of Class 2.

In yet other embodiments, a paint product including the particulate composition of the invention has a cracking resistance above 800 μm. In yet other embodiments, a paint product including the particulate composition of the invention has a cracking resistance above 900 μm.

For the avoidance of doubt the present invention also embraces the following subject-matter as defined in the following numbered paragraphs.
1. A particulate composition comprising the following components, expressed in weight % of the composition,
   55%≦SiO₂; and
   MgO≦30%,
   characterized by a bimodal particle size distribution exhibiting, when measured by laser diffraction, a first peak from about 1μm to about 10μm, and a second peak from about 15μm to about 150μm.
2. The composition of paragraph 1 which comprises SiO₂ at a level of 60% by weight or more, such as 61% or more.
3. The composition of paragraphs 1 or 2 which comprises SiO₂ at a level of 65% by weight or less, preferably at a level of 63% by weight or less, or at a level of 65% by weight or less and more than 0% by weight, preferably at a level of 63% by weight or less and more than 0% by weight.
4. The composition of any one of paragraphs 1 to 3 which comprises MgO at a level of 29% by weight or less, preferably at a level of 28% by weight or less, or at a level of 29% by weight or less and more than 0% by weight, preferably at a level of 28% by weight or less and more than 0% by weight.
5. The composition of any one of paragraphs 1 to 4 which comprises MgO at a level of 10% by weight or more, preferably at a level of 20% by weight or more.
6. The composition of any one of paragraphs 1 to 5 which comprises Al₂O₃ at a level of 2% by weight or more, preferably at a level of 3% by weight or more, still more preferably at a level of 3.5% by weight or more.
7. The composition of any one of paragraphs 1 to 6 which comprises Al₂O₃ at a level of 15% by weight or less, preferably at a level of 9% by weight or less, or at a level of 15% by weight or less and more than 0% by weight, preferably at a level of 9% by weight or less and more than 0% by weight.
8. The composition of any one of paragraphs 1 to 7 which comprises K₂O at a level of 0.1% by weight or more, preferably at a level of 0.3% by weight or more, still more preferably at a level of 0.5% by weight or more.
9. The composition of any one of paragraphs 1 to 8 which comprises K₂O at a level of 1.0% by weight or less, preferably at a level of 0.8% by weight or less, or at a level of 1.0% by weight or less and more than 0% by weight, preferably at a level of 0.8% by weight or less and more than 0% by weight.
10. The composition of any one of paragraphs 1 to 9 characterized by a bimodal particle size distribution exhibiting, when measured by laser diffraction, a first peak from about 2μm to about 5μm, and a second peak from about 30μm to about 50μm.
11. The composition of any ono of paragraphs 1 to 10 comprising a fine particle fraction characterized by a d₅₀, when measured by laser diffraction, ranging from 1 to 10 μm, preferably from 2 to 5 μm, still more preferably from 2.5 to 4.0 μm.
12. The composition of any one of paragraphs 1 to 11 comprising a coarse particle fraction characterized by a d₅₀, when measured by laser diffraction, ranging from 15 to 150 μm, preferably from 30 to 50 μm, still more preferably from 35 to 45 μm.
13. The composition of any one of paragraphs 1 to 12 comprising from 40% to 90% by weight of a first particulate composition component, preferably from 50% to 80% by weight of a first particulate composition component, still more preferably from 60% to 70% by weight of a first particulate composition component.
14. The composition of any one of paragraphs 1 to 13 comprising from 1% to 30% by weight of a second particulate composition component, preferably from 5% to 25% by weight of a second particulate composition component, still more preferably from 10% to 20% by weight of a second particulate composition component.
15. The composition of any one of paragraphs 1 to 14 comprising from 1% to 15% by weight of a third particulate composition component, preferably from 5% to 10% by weight of a third particulate composition component, still more preferably from 6% to 9% by weight of a third particulate composition component.
16. The composition of any one of paragraphs 1 to 15 comprising from 1% to 30% by weight of a fourth particulate composition component, preferably from 5% to 20% by weight of a fourth particulate composition component, still more preferably from 10% to 15% by weight of a fourth particulate composition component.
17. The composition of any one of paragraphs 1 to 12 comprising from 40% to 90% by weight of a first particulate composition component, from 1% to 30% by weight of a second particulate composition component, from 1% to 15% by weight of a third particulate composition component, and from 1% to 30% by weight of a fourth particulate composition component.
18. The composition of any one of paragraphs 1 to 12 comprising from 50% to 80% by weight of a first particulate composition component, from 5% to 25% by weight of a second particulate composition component, from 5% to 10% by weight of a third particulate composition component, and from 5% to 20% by weight of a fourth particulate composition component.
19. The composition of any one of paragraphs 1 to 12 comprising from 60% to 70% by weight of a first particulate composition component, from 10% to 20% by weight of a second particulate composition component, from 6% to 9% by weight of a third particulate composition component, and from 10% to 15% by weight of a fourth particulate composition component.
20. A method for improving a paint product, the method comprising a step of adding a particulate composition of any one of paragraphs 1 to 19 to a paint product, followed by a step of mixing to produce the improved paint product.
21, The method of paragraph 20, wherein from about 1% to about 30% by weight, preferably from about 1% to about 10% by weight, more preferably from about 3% to about 8% by weight, still more preferably from about 5% to about 6% by weight of said particulate composition is added to the paint product.
22. The method of any one of paragraphs 20 or 21, wherein the paint product has a PVC level above 30%, preferably above 40%, more preferably above 50%, still more preferably above 60%, still more preferably above 70%.
23. A paint product obtainable by the method of any one of paragraphs 20 to 22.

### EXAMPLES

### Example

### Paint Formulations

A particulate composition according to the invention was added at an amount of 5.7% weight to a base paint. The final Pigment Volume Concentration was 70%.

As can be seen in the results table below, the paint product displayed very good optical characteristics, as exemplified by the Dry opacity and Gloss parameters.

These characteristics were maintained for formulations 2 and 3, despite a reduction in the resin amount of up to 20% for formulation 3.

The results show that the optical properties were maintained ss all three formulations.

| Formulation # | 1 | 2 | 3 |
|---|---|---|---|
| Ingredients | % w | % w | % w |
| H₂O + additives | 39.4 | 41.8 | 42.5 |
| TiO₂ | 5.0 | 5.0 | 5.0 |
| Carbonate | 33.3 | 34.1 | 34.8 |
| Particulate composition | 5.7 | 5.7 | 5.7 |
| Binder | 15.0 | 13.5 | 12.0 |
| TOTAL | 100.0 | 100.0 | 100.0 |

Contrast chart 100 μm

| | | | |
|---|---|---|---|
| Dry Opacity, Yb/Yw % | 88.6 | 88.7 | 90.7 |
| Gloss 85° | 2.3 | 2.4 | 2.5 |

Scrub resistance

| | | | |
|---|---|---|---|
| Loss of μm | 10 | 12 | 14 |
| Class | 2 | 2 | 2 |

Cracking resistance

| | | | |
|---|---|---|---|
| From 1500 to 300 μm | 1000 | 1000 | 1000 |

1. A particulate composition comprising the following components, expressed in weight % of the composition,
55%≦SiO₂; and
MgO≦30%,
characterized by a bimodal particle size distribution exhibiting, when measured by laser diffraction, a first peak from about 1 μm to about 10 μm, and a second peak from about 15 μm to about 150 μm.

2. The particulate composition of claim 1, wherein the particulate composition is a paint additive and a paint comprising the particulate composition exhibits:
(a) improved scrub resistance;
(b) improved cracking resistance;
(c) improved anti-corrosion properties;
(d) enhanced durability;
(e) better matting effect on the film coating;
(f) lower resin requirements; or
(g) lower titanium dioxide requirements,
when compared to the paint properties in absence of said particulate composition.

3. The particulate composition of claim 1, wherein the composition comprises the following components, expressed in weight % of the composition,
60%≦SiO₂≦65%;
2%≦Al₂O₃≦15%; and
10%≦MgO≦30%.

4. The particulate composition of claim 1, wherein the composition comprises the following components, expressed in weight % of the composition,
61%≦SiO₂≦63%;
3%≦Al₂O₃≦9%; and
20%≦MgO≦30%.

5. A product comprising the particulate composition of claim 1.

6. The product of claim 5, wherein the product is a paint product.

7. The product of claim 5, wherein the product is an ink composition.

8. The product of claim 6, wherein the product comprises from 1% to 10% by weight of the particulate composition.

9. The product of claim 6, wherein the product comprises from 5% to 6% by weight of the particulate composition.

10. A method for improving a paint product, the method comprising adding a particulate composition according to claim 1 to the paint product.

11. The method of claim 10, wherein the paint product displays one or more of the following:
(a) improved scrub resistance;
(b) improved cracking resistance;
(c) improved anti-corrosion properties;
(d) enhanced durability;
(e) better matting effect on the film coating;
(f) lower resin requirements, and
(g) lower titanium dioxide requirements,
compared to the same paint product in absence of said particulate composition.

12. The method of claim 10, wherein the improved paint product has improved whiteness, dry opacity, or barrier properties:
(f)
compared to the same paint product in absence of said particulate composition.

13. (canceled)

14. The method of claim 12, wherein the improved paint product displays one or more of the following:
(g) improved scrub resistance;
(h) improved cracking resistance;
(i) improved anti-corrosion properties;
(j) enhanced durability;
(k) better matting effect on the film coating; and
(l) lower resin requirements, compared to the same paint product in absence of said particulate composition,

15. The product of claim 5, wherein the product is a resin composition.
